(19) United States
(12) Patent Application Publication
(10) Pub. No.: US 2025/0003028 A1
(43) Pub. Date: Jan. 2, 2025

(54) DIFFUSION CONTROLLED REACTION BASED ALLOYING ANODES THROUGH NANOSTRUCTURING

(71) Applicant: KOREA UNIVERSITY RESEARCH AND BUSINESS FOUNDATION, Seoul (KR)

(72) Inventors: Yong-Mook KANG, Seoul (KR); Gilseob KIM, Seoul (KR); Jing ZHANG, Seoul (KR)

(21) Appl. No.: 18/419,327

(22) Filed: Jan. 22, 2024

(30) Foreign Application Priority Data
Jun. 28, 2023 (KR) 10-2023-0083120

(51) Int. Cl. C22C 1/10; C22C 32/00; H01M 4/02; H01M 4/04

(52) U.S. Cl. CPC C22C 1/1042; C22C 32/0084; H01M 4/0488; H01M 2004/021; H01M 2004/027

(57) ABSTRACT

Disclosed is a diffusion controlled reaction based alloying anodes through nanostructuring. The diffusion controlled reaction based alloying anode includes a carbon-alloy-based anode material nanocomposite composed of a carbon matrix and alloy-based anode material particles and formed via a diffusion-controlled induction process that is means for inducing the diffusion-controlled reaction.

### CROSS-REFERENCE TO RELATED APPLICATIONS

This application claims priority under 35 U.S.C. § 119 to Korean Patent Application No. 10-2023-0083120 filed on Jun. 28, 2023, in the Korean Intellectual Property Office, the disclosures of which are incorporated by reference herein in their entireties.

### BACKGROUND

Embodiments of the present disclosure described herein relate to a diffusion controlled reaction based alloying anodes through nanostructuring.

A lithium ion battery is widely used in everything from a small electronic device to an electric vehicle and a large-scale energy storage facility, but to meet increasing energy demand, a new electrochemical system with high energy density that may replace the lithium ion battery is needed.

Various next-generation ion batteries, including a potassium ion battery, have a potential to replace the lithium ion battery because they are inexpensive and have a standard potential of high voltage corresponding to that of the lithium ion battery.

In one example, as an anode material for the next-generation ion batteries, an alloy-based anode may meet high energy density, but such alloy-based anode lowers reversibility of an alloy reaction via physical deterioration caused by non-uniform ion diffusion and high level of volume expansion. In addition, a charge-carrying ion with an ionic radius greater than that of lithium may accelerate the above-mentioned deterioration process and cause a decrease in a battery lifespan.

Specifically, depending on a reaction mechanism related to the alloy-based anode, during penetration of the charge-carrying ions, a parent phase structure is destroyed to form a thin amorphous transition layer at an interface with the parent phase, and then a phase transition may occur as an ion concentration continues to increase.

Such phase transition is influenced by a rate of ion transfer, and there are two reaction rate determining stages. A case in which a diffusion rate of ions inside the anode determines an overall reaction corresponds to a diffusion-controlled reaction (DCR), and a case in which a diffusion rate of the ions passing through a phase boundary determines the overall reaction corresponds to an interface-controlled reaction (ICR). In this regard, the diffusion-controlled reaction and the interface-controlled reaction are distinguished from each other. In addition, the interface-controlled reaction is associated with a two-phase reaction at the phase boundary and has slow movement of the phase boundary and high activation energy of the reaction, thereby causing anisotropic ion diffusion. On the contrary, the diffusion-controlled reaction is associated with a one-phase reaction, showing a high isotropic diffusion rate via continuous ion diffusion.

In particular, the interface-controlled reaction not only causes slow internal diffusion of the charge-carrying ions, but also applies significant anisotropic stress and a strain field to particles and causes mechanical deterioration such as particle breakage, thereby causing capacity reduction of the alloy-based anode. Therefore, a strategy to prevent the interface-controlled reaction is needed.

One of existing representative research methodologies is to reduce a particle size of the alloy-based anode, and the particle size reduction of the alloy-based anode has been shown to suppress particle fragmentation resulted from charging/discharging in a technical field of the lithium ion battery. However, such method is limited to improving lifespan characteristics by preventing the particle breakage, and is different from improving characteristics of the ion battery under the diffusion-controlled reaction.

### SUMMARY

Embodiments of the present disclosure provide a diffusion controlled reaction based alloying anodes through nanostructuring that uses a carbon-alloy-based anode material nanocomposite and delays an occurrence of a phase separation via atomization and complexation of the carbon-alloy-based anode material nanocomposite to induce a diffusion-controlled reaction that expands a one-phase reaction section, and accordingly, achieve long life and high output in a next-generation ion battery.

According to an embodiment, a diffusion controlled reaction based alloying anodes through nanostructuring includes a carbon-alloy-based anode material nanocomposite composed of a carbon matrix and alloy-based anode material particles, wherein the carbon-alloy-based anode material nanocomposite is formed via a diffusion-controlled induction process that is means for inducing the diffusion-controlled reaction.

The diffusion-controlled reaction may be a reaction of extending a one-phase reaction section by delaying an occurrence of a phase separation.

The diffusion-controlled induction process may correspond to atomization of the alloy-based anode material particles via a dual-polymer protect-calcination and complexation of the alloy-based anode material particles and the carbon matrix.

The carbon-alloy-based anode material nanocomposite may store alkali ions with a multi-phase reaction suppressed via a non-equilibrium reaction by the diffusion-controlled reaction, and the carbon-alloy-based anode material nanocomposite may store the alkali ions via the non-equilibrium reaction that is a reaction of forming a solid solution alloy as the alkali ions are intercalated into the alloy-based anode material particles with the phase separation delayed because of a reduction in a miscibility gap in the alloy-based anode material particles, an increase in critical nucleation energy, and an increase in solubility of the alkali ions.

The carbon-alloy-based anode material nanocomposite may include an embedded structure where the alloy-based anode material particles are dispersed and embedded in the carbon matrix, and a weight ratio of the carbon matrix and the alloy-based anode material particles in the carbon-alloy-based anode material nanocomposite may be in a range of 1:99 to 99:1.

The alloy-based anode material particles may have a particle size satisfying a range of 0.5 to 30 nm.

The alloy-based anode material particles may be nanodots made of one metal selected from a group of Bi, Si, Sn, Ge, Sb, P, Al, Zn, Ga, Pb, Ag, Au, and In, a metal oxide containing one element selected from the group, a metal nitride containing one element selected from the group, or a metal phosphide containing one element selected from the group.

The carbon matrix may contain at least one material selected from a group consisting of reduced graphene, graphene, and a carbon nanotube.

According to an embodiment, a method for manufacturing a diffusion controlled reaction based alloying anodes through nanostructuring includes obtaining a carbon-alloy-based anode material nanocomposite composed of a carbon matrix and alloy-based anode material particles, wherein the carbon-alloy-based anode material nanocomposite is formed via a diffusion-controlled induction process that is means for inducing the diffusion-controlled reaction.

The diffusion-controlled induction process may include performing atomization of the alloy-based anode material particles via a dual-polymer protect-calcination and complexation of the alloy-based anode material particles and the carbon matrix, and the performing of the atomization of the alloy-based anode material particles and the complexation of the alloy-based anode material particles and the carbon matrix may include synthesizing a preliminary composite composed of preliminary alloy-based anode material particles coated with a first polymer and the carbon matrix, coating a second polymer on a surface of the synthesized preliminary composite, and calcining the preliminary composite coated with the second polymer in a mixed gas atmosphere.

### BRIEF DESCRIPTION OF THE FIGURES

The above and other objects and features of the present disclosure will become apparent by describing in detail embodiments thereof with reference to the accompanying drawings.

FIG. 1 is a diagram for illustrating a diffusion controlled reaction based alloying anodes through nanostructuring according to an embodiment of the present disclosure.

FIG. 2A is a scanning electron microscope photograph of Present Example 1.

FIG. 2B is a transmission electron microscope photograph of Present Example 1.

FIG. 2C is a particle size distribution graph of Present Example 1.

FIG. 2D is an XRD analysis graph of Present Example 1.

FIG. 2E is a scanning electron microscope photograph of Comparative Example 1.

FIG. 2F is a transmission electron microscope photograph of Comparative Example 1.

FIG. 2G is a particle size distribution graph of Comparative Example 1.

FIG. 2H is an XRD analysis graph of Comparative Example 1.

FIG. 3A is a charging/discharging curve of Present Example 2.

FIG. 3B is a charging/discharging curve of Comparative Example 2.

FIG. 4A is a graph showing the lifespan characteristics under the current density of 0.05 Ag⁻¹ of Present Example 2 and Comparative Example 2.

FIG. 4B is a graph showing the output characteristics of Present Example 2 and Comparative Example 2.

FIG. 4C is a graph showing the lifespan characteristics under the current density of 0.5 Ag⁻¹ of Present Example 2 and Comparative Example 2.

FIG. 5A is a contour graph of a synchrotron X-ray diffraction pattern of Present Example 1.

FIG. 5B is a result of analyzing a synchrotron X-ray diffraction pattern of Comparative Example 1.

FIG. 6 is a diagram showing results of microstructure analysis during a charging process according to Present Example 1 and Comparative Example 1 of the present disclosure.

FIGS. 7A to 7C are transmission electron microscope photographs after the 100 charging/discharging cycles of Present Example 1.

FIG. 7D is a result of selected area electron diffraction analysis after the 100 charging/discharging cycles of Present Example 1.

FIGS. 7E to 7G are transmission electron microscope photographs after the 100 charging/discharging cycles of Comparative Example 1.

FIG. 7H is a result of the selected area electron diffraction analysis after the 100 charging/discharging cycles of Comparative Example 1.

### DETAILED DESCRIPTION

To fully understand a composition and effects of the present disclosure, a preferred embodiment of the present disclosure will be described in detail with reference to the attached drawings.

The present disclosure may not be limited to the embodiments disclosed below, but may be implemented in various forms and various modifications and changes may be made. However, a description of the present embodiment is provided to ensure that the disclosure of the present disclosure is complete and to completely inform those skilled in the art of the technical field to which the present disclosure belongs to the scope of the invention. In the attached drawings, the components are enlarged in size for convenience of description, and a proportion of each component may be exaggerated or reduced.

The terms used herein are intended to describe the embodiments and are not intended to limit the present disclosure. Additionally, unless otherwise defined, the terms used herein may be interpreted to have meanings commonly known to those skilled in the art. As used herein, a singular form also includes a plural form, unless specifically stated otherwise in the context. As used herein, ‘comprises’ and/or ‘comprising’ specifies the presence of the stated components, steps, operations, and/or elements, but does not preclude the presence or addition of one or more other components, steps, operations, and/or elements.

As used herein, when a layer is referred to as being ‘on’ another layer, the layer may be formed directly on top of said another layer or there may be a third layer interposed therebetween. Although terms such as first and second are used herein to describe various areas, layers, and the like, such areas and layers should not be limited by such terms. Such terms are merely used to distinguish any specific area or layer from another area or layer. Accordingly, a portion referred to as a first portion in one embodiment may be referred to as a second portion in another embodiment. Embodiments described and illustrated herein also include complementary embodiments thereof. Portions indicated with the same reference numerals throughout the present document represent the same components.

In the present disclosure, a diffusion-controlled reaction was designed to be realized at an anode for a metal ion battery with an alloying behavior. Specifically, long life and high output of the metal ion battery have been achieved by performing atomization of alloy-based anode material particles and complexation of the alloy-based anode material particles and a carbon matrix in dual-polymer protect-calcination to cause a one-phase reaction of the alloy-based anode material particles. In addition, high energy density, which is an advantage of an alloy-based anode, has been achieved, and mechanical deterioration caused by phase transition, which is a disadvantage, has been reduced by enabling a high diffusion rate of alkali ions, uniform interfacial diffusion, and uniform volume expansion via realization of the diffusion-controlled reaction to improve a battery performance and prove usability for various metal ion battery anode materials.

In addition, a diffusion controlled reaction based alloying anode of the present disclosure was designed to induce a solid solution reaction while delaying a phase separation phenomenon in a non-equilibrium state and to enable storage of the alkali ions via uniform interfacial diffusion, so that the diffusion controlled reaction based alloying anode may be expanded not only to a lithium ion battery, but also to a sodium ion battery, a zinc ion battery, and an aluminum ion battery, which are next-generation ion batteries.

### Diffusion Controlled Reaction Based Alloying Anode

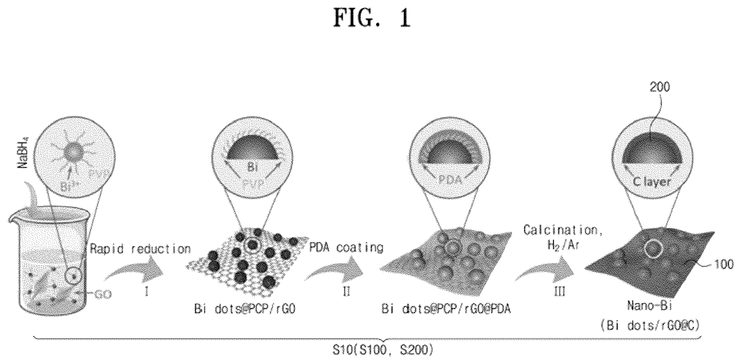

FIG. 1 is a diagram for illustrating a diffusion controlled reaction based alloying anodes through nanostructuring according to an embodiment of the present disclosure.

First, referring to FIG. 1, the diffusion controlled reaction based alloying anodes through nanostructuring according to one embodiment of the present disclosure may include a carbon-alloy-based anode material nanocomposite composed of a carbon matrix 100 and alloy-based anode material particles 200 and formed via a diffusion-controlled induction process, which is means for inducing the diffusion-controlled reaction.

In this regard, the diffusion-controlled reaction is a reaction that is associated with the one-phase reaction and causes the high isotropic diffusion rate via the continuous ion diffusion, and refers to a case in which an alloying behavior rate is controlled by ion diffusion inside the anode material.

More specifically, the diffusion-controlled reaction is a reaction that expands a one-phase reaction section by delaying an occurrence of the phase separation, and delays the phase separation phenomenon that continuously occurs within the anode material to allow continuous phase transition to occur as the one-phase reaction, thereby allowing the alloying behavior to occur within the carbon-alloy-based anode material nanocomposite.

Accordingly, the carbon-alloy-based anode material nanocomposite may store the alkali ions via the one-phase reaction, which is a reaction in which the alkali ions are intercalated into the alloy-based anode material particles to cause a single-phase transition.

Specifically, the diffusion controlled reaction based alloying anode of the present disclosure may undergo a phase transition process of the anode material in the state in which the phase separation is delayed when charge-carrying ions such as the alkali ions are intercalated into the anode material in the alloying behavior, which is an anode reaction mechanism, as the alloying behavior rate is controlled by the diffusion-controlled reaction, that is, the ion diffusion inside the anode material.

In addition, the diffusion controlled reaction based alloying anode of the present disclosure may undergo a non-equilibrium reaction by the diffusion-controlled reaction, that is, as the alloying behavior rate is controlled by the ion diffusion inside the anode material particles. The diffusion controlled reaction based alloying anode of the present disclosure may have a feature of enabling a reversible single-phase transformation without the phase separation during the alloying behavior, which is the anode reaction mechanism.

Specifically, the diffusion controlled reaction based alloying anode of the present disclosure may enable the reversible single-phase transformation via the non-equilibrium reaction in which a solid solution phase transition reaction proceeds without the phase separation as a critical concentration, which is a critical value of an ion concentration at which the phase separation occurs, increases when the charge-carrying ions are intercalated into the anode material to form a solid solution alloy.

In other words, the diffusion controlled reaction based alloying anode of the present disclosure may have the alloying behavior in the form in which the one-phase reaction section, which is a section where the single-phase transition occurs continuously, is expanded by delaying the phase separation phenomenon, which continuously occurs within the anode material as the carbon-alloy-based anode material nanocomposite is formed via the diffusion-controlled induction process that induces the diffusion-controlled reaction.

Specifically, the diffusion-controlled induction process may be atomization of the alloy-based anode material particles 200 via the dual-polymer protect-calcination and complexation of the alloy-based anode material particles 200 and the carbon matrix 100. In the present disclosure, there is no particular limitation as the process is the process of inducing the diffusion-controlled reaction, which is the reaction that expands the one-phase reaction section by delaying the occurrence of the phase separation of the diffusion controlled reaction based alloying anode, that is, the process allowing the diffusion controlled reaction based alloying anode to have the alloying behavior in the form in which the one-phase reaction section is expanded.

As a result, the diffusion-controlled reaction may increase critical nucleation energy and solubility of the alkali ions and reduce a miscibility gap to promote the internal diffusion of the alkali ions when the alkali ions are intercalated into the alloy-based anode material particles 200.

In one embodiment of the present disclosure, the method of storing the alkali ions of the alloy-based anode material particles 200 by the diffusion-controlled reaction may proceed as the phase transition in which the phase separation is delayed as the alloy-based anode material particles 200 are atomized via the diffusion-controlled induction process to reduce the miscibility gap, increase the critical nucleation energy, and the solubility of the alkali ions in the alloy-based anode material particles 200. In other words, the alkali ions may be stored as the one-phase reaction resulted from a progress of the non-equilibrium reaction.

Specifically, in the present disclosure, the carbon-alloy-based anode material nanocomposite may store the alkali ions in a state in which a multi-phase reaction is suppressed via the non-equilibrium reaction by the diffusion-controlled reaction. More specifically, the carbon-alloy-based anode material nanocomposite stores the alkali ions via the non-equilibrium reaction, which is the reaction in which the alkali ions are intercalated into the alloy-based anode material particles 200 to form the solid solution alloy in the state in which the phase separation is delayed because of the reduction of the miscibility gap within the alloy-based anode material particles 200, the increase in the critical nucleation energy, and the increase in the solubility of the alkali ions.

Next, referring again to FIG. 1, the carbon-alloy-based anode material nanocomposite based on the diffusion controlled reaction based alloying anode of the present disclosure will be described in detail.

The carbon-alloy-based anode material nanocomposite according to one embodiment of the present disclosure may include an embedded structure in which the alloy-based anode material particles 200 are dispersed and embedded in the carbon matrix 100.

Specifically, the carbon-alloy-based anode material nanocomposite may be obtained by attaching, adhering, or encapsulating the alloy-based anode material particles 200 on the carbon matrix 100 and then carbonizing the particles. When the nanocomposite is applied to a battery, despite volume expansion and contraction based on cycling, integrity of the alloy-based anode material particles 200 may be maintained, and at the same time, an electronic conduction path to the alloy-based anode material particles 200 based on the carbon matrix 100 may be maintained.

Additionally, a weight ratio of the carbon matrix and the alloy-based anode material particles in the carbon-alloy-based anode material nanocomposite may be in a range of 1:99 to 99:1.

In other words, the carbon-alloy-based anode material nanocomposite may contain 1 to 99% by weight of the carbon matrix and 99 to 1% by weight of the alloy-based anode material particles, based on a total weight of the carbon-alloy-based anode material nanocomposite, and may have various mass ratios depending on types of the carbon matrix and the alloy-based anode material particles.

In a preferred embodiment of the present disclosure, the carbon-alloy-based anode material nanocomposite may be composed of 50 to 70% by weight of the carbon matrix and 30 to 50% by weight of the alloy-based anode material particles, based on the total weight of the carbon-alloy-based anode material nanocomposite, but the present disclosure may not be limited thereto.

In this regard, the alloy-based anode material particles 200 may have a particle size that satisfies a range of 0.5 to 30 nm. When the particle size exceeds the above range, as the interface-controlled reaction rather than the diffusion-controlled reaction is induced during a charging and discharging process of the metal ion battery, lifespan may be deteriorated because of the volume expansion and the phase separation.

In addition, the alloy-based anode material particles 200 may include a carbon coating layer formed by carbonization of a polymer, thereby having a surface contact function that maintains conductivity of a cluster of nano-sized particles in the nanocomposite. In addition, electrochemical reversibility and conductivity inside the diffusion controlled reaction based alloying anode may be improved.

In addition, the alloy-based anode material particles 200 may be nanodots made of one metal selected from a group consisting of Bi, Si, Sn, Ge, Sb, P, Al, Zn, Ga, Pb, Ag, Au, and In, a metal oxide containing one element selected from the group, a metal nitride containing one element selected from the group, or a metal phosphide containing one element selected from the group.

The carbon matrix 100 may contain at least one material selected from a group consisting of reduced graphene, graphene, and a carbon nanotube, and may serve as a matrix to strengthen structural stability of the carbon-alloy-based anode material nanocomposite after the carbonization via calcination treatment.

In addition, the carbon matrix 100 may include the carbon coating layer formed by the carbonization of the polymer Accordingly, electron transfer to the alloy-based anode material particles 200 may be promoted to reduce a battery resistance.

In one example, the diffusion controlled reaction based alloying anodes through nanostructuring according to one embodiment of the present disclosure may include the carbon-alloy-based anode material nanocomposite, a conductive material, an adhesive, and a current collector. The carbon-alloy-based anode material nanocomposite may be used as the anode material.

In this regard, the diffusion controlled reaction based alloying anode may be manufactured by mixing the carbon-alloy-based anode material nanocomposite, the conductive material, and the adhesive with each other to prepare a composition for forming an anode material layer, and then applying the composition to the current collector.

In this regard, the composition for forming the anode material layer may be prepared by adding the carbon-alloy-based anode material nanocomposite, the conductive material, and the adhesive to N-methyl-2-pyrrolidone (NMP) at a preset mass ratio and mixing the added components with each other. In a preferred embodiment of the present disclosure, the preset mass ratio may be a ratio of 8:1:1 in an order of the carbon-alloy-based anode material nanocomposite, the conductive material, and the adhesive, but the present disclosure may not be limited thereto.

In addition, the conductive material may include a conductive carbon material including acetylene black, carbon black, and the like, the adhesive may include a fluorine-based polymer including polyvinylidene fluorine and the like, and the current collector may be a copper foil.

### Diffusion Controlled Reaction Based Alloying Anode Manufacturing Method

Referring to FIG. 1, a manufacturing method (S10) of the diffusion controlled reaction based alloying anodes through nanostructuring according to one embodiment of the present disclosure includes step (S100) of obtaining the carbon-alloy-based anode material nanocomposite composed of the carbon matrix and the alloy-based anode material particles and formed via the diffusion-controlled induction process, which is the means for inducing a diffusion-controlled reaction.

In this regard, the diffusion-controlled induction process may include step (S110) of performing the atomization of the alloy-based anode material via the dual-polymer protect-calcination and the complexation of the alloy-based anode material particles and the carbon matrix.

Specifically, step (S110) of performing the atomization of the alloy-based anode material and the complexation of the alloy-based anode material particles and the carbon matrix includes step (S111) of synthesizing a preliminary composite composed of preliminary alloy-based anode material particles coated with a first polymer and the carbon matrix, step (S112) of coating a second polymer on a surface of the synthesized preliminary composite, and step (S113) of calcining the preliminary composite coated with the second polymer under a mixed gas atmosphere.

Hereinafter, step S110 will be described in detail. In S110 step, polyvinylpyrrolidone as the first polymer and polydopamine (PDA) as the second polymer are used as carbon precursors, graphene oxide is used as a carbon matrix precursor, and a metal compound containing metal ions for forming the nanodots is used as an alloy-based anode material particle precursor to obtain the carbon-alloy-based anode material nanocomposite via the atomization.

In this regard, the metal compound may be at least one selected from a group consisting of Bi(NO₃)₃·5H₂O, BiCl₃, Bi₂(SO₄)₃, Bi(CH₃COO)₃, and Bi[CO₂CH₂(CO₂)(OH)CH₂CCO₂].

As described above, step S110 includes steps S111, S112, and S113, and each step will be described in detail.

In one embodiment according to the present disclosure, step (S111) of synthesizing the preliminary composite composed of the preliminary alloy-based anode material particles coated with the first polymer and the carbon matrix is a step of synthesizing a preliminary composite with an embedded structure in which the preliminary alloy-based anode material particles coated with the first polymer are dispersed and embedded in the carbon matrix.

In step S111, the metal compound containing the metal ions to form the nanodots and the first polymer, which is the carbon precursor, are added to a mixed solution of ethanol and glycerol and dissolved to prepare a mixture.

Thereafter, the prepared mixture is primarily stirred for 1 hour, and then a mixed solution of graphene oxide, which is the carbon matrix precursor, and ethanol is added to the primarily stirred mixture and sonicated for 30 to 40 minutes.

Next, the sonicated mixture is heat-treated at a temperature of 30 to 50° C. for 30 minutes, and then NaBH₄ is added to the heat-treated mixture and secondarily stirred.

Thereafter, the secondarily stirred mixture is centrifuged via a centrifuge and then a first precipitate is extracted.

Next, the extracted first precipitate is washed and dried in a vacuum atmosphere at a temperature of 50 to 70° C. for 12 hours to synthesize the preliminary composite with the embedded structure in which the preliminary alloy-based anode material particles coated with the first polymer are dispersed and embedded in the carbon matrix.

In one embodiment according to the present disclosure, step (S112) of coating the second polymer on the surface of the synthesized preliminary composite is a step of coating the second polymer on the carbon matrix and the preliminary alloy-based anode material particles coated with the first polymer.

In step S112, the preliminary composite synthesized in step S111 is dispersed in a Tris-buffer solution with a pH of 8.5 and a concentration of 10 mM, and then tertiarily stirred.

Thereafter, dopamine hydrochloride is added to the mixture undergoing the tertiary stirring, and the tertiary stirring is maintained for 24 hours to polymerize the dopamine hydrochloride into dopamine.

Next, the polymerized mixture is centrifuged via the centrifuge and a second precipitate is extracted.

Thereafter, the extracted second precipitate is washed with distilled water and dried in the vacuum atmosphere at the temperature of 50 to 70° C. for 12 hours to coat the second polymer on the carbon matrix and the alloy preliminary-based anode material particles coated with the first polymer.

In one embodiment according to the present disclosure, step (S113) of calcining the preliminary composite coated with the second polymer under the mixed gas atmosphere is a step of forming the carbon coating layer on the carbon matrix and the preliminary alloy-based anode material particles coated with the second polymer.

In step S113, the preliminary composite coated with the second polymer in step S112 is calcined at a temperature of 600 to 700° C. for 2 hours under a mixed gas atmosphere of hydrogen gas and argon gas.

In this regard, in the calcination process, a temperature increase rate may be 5° C. for each minute.

Accordingly, the manufacturing method (S10) of the diffusion controlled reaction based alloying anodes through nanostructuring according to one embodiment of the present disclosure includes step (S111) of performing the atomization of the alloy-based anode material via the dual-polymer protect-calcination of coating and then carbonizing the polymer, and the complexation of the alloy-based anode material particles and the carbon matrix, so that the carbon-alloy-based anode material particles nanocomposite composed of the carbon matrix and the alloy-based anode material particles may be formed, and the carbon matrix and the alloy-based anode material particles may include the carbon coating layer on the surfaces thereof.

The manufacturing method (S10) of the diffusion controlled reaction based alloying anodes through nanostructuring according to one embodiment of the present disclosure may further include step (S200) of preparing the composition for forming the anode material layer by mixing the carbon-alloy-based anode material nanocomposite, the conductive material, and the adhesive obtained in step S100 with each other and then applying the prepared composition for forming the anode material layer to the current collector.

In step S200, the composition for forming the anode material layer may be prepared by adding the carbon-alloy-based anode material nanocomposite, the conductive material, and the adhesive to the N-methyl-2-pyrrolidone (NMP) at the preset mass ratio and then mixing the added components with each other. In a preferred embodiment of the present disclosure, the preset mass ratio may be the ratio of 8:1:1 in the order of the carbon-alloy-based anode material nanocomposite, the conductive material, and the adhesive.

In addition, the application process in step S200 may be a process of applying the prepared composition for forming the anode material layer onto the current collector and then heat-treating the composition in the vacuum atmosphere at a temperature of 110 to 130° C. for 5 hours.

### Present Example 1: Manufacturing of Diffusion Controlled Reaction Based Alloying Anode

The polyvinylpyrrolidone (PVP), which is the first polymer, and the polydopamine (PDA), which is the second polymer, were used as the carbon precursor, the graphene oxide was used as the carbon matrix precursor, and the Bi(NO₃)₃·5H₂O, which is the metal compound containing bismuth (Bi) ions for forming the nanodots, was used as the alloy-based anode material particle precursor.

A carbon-alloy-based anode material nanocomposite composed of 60% by weight of the reduced graphene as the carbon matrix and 40% by weight of bismuth (Bi) as the alloy-based anode material particles was obtained via the diffusion-controlled induction process, which is the atomization of the alloy-based anode material particles via the dual-polymer protect-calcination using the PVP and the PDA. A composition for forming the anode material layer was prepared by mixing the obtained carbon-alloy-based anode material nanocomposite, the carbon black as the conductive material, and the polyvinylidene fluorine as the adhesive with each other at the ratio of 8:1:1. After applying the prepared composition for forming the anode material layer to the copper current collector, the composition was heat-treated for 5 hours at a temperature of 120° C. in the vacuum atmosphere to manufacture a diffusion controlled reaction based alloying anode (Present Example 1).

### Comparative Example 1: Manufacture of Bulk Alloy-Based Anode

The graphene oxide was used as the carbon matrix precursor, and the Bi(NO₃)₃·5H₂O, which is the metal compound containing the bismuth (Bi) ions for forming the nanodots, was used as the alloy-based anode material particle precursor.

A carbon-alloy-based anode material bulk composite was obtained via the synthesis process in Present Example 1 excluding the use of the PVP and the PDA. The obtained carbon-alloy-based anode material bulk composite, the carbon black as the conductive material, and the polyvinylidene fluorine as the adhesive were mixed with each other at the mass ratio of 8:1:1 to prepare a composition for forming the anode material layer. After applying the prepared composition for forming the anode material layer onto the copper current collector, the composition was heat-treated for 5 hours at the temperature of 120° C. in the vacuum atmosphere to manufacture a diffusion controlled reaction based alloying anode (Comparative Example 1).

### Present Example 2: Manufacture of Metal Ion Battery Including Diffusion Controlled Reaction Based Alloying Anode

The diffusion controlled reaction based alloying anode according to Present Example 1 was used, potassium metal (K-metal) was used as a cathode, a mixed solution of ethylene carbonate (EC):diethyl carbonate (DEC) with a volume ratio of 1:1 was used as an electrolyte, and glass fiber was used as a separator to manufacture a potassium ion battery, a CR 2032 half-cell, according to an existing manufacturing method (Present Example 2).

### Comparative Example 2: Manufacture of Metal Ion Battery Including Alloy-Based Anode

The bulk alloy-based anode according to Comparative Example 1 was used, the potassium metal (K-metal) was used as the cathode, the mixed solution of the ethylene carbonate (EC):the diethyl carbonate (DEC) with the volume ratio of 1:1 was used as the electrolyte, and the glass fiber was used as the separator to manufacture a potassium ion battery, a CR 2032 half-cell, according to the existing manufacturing method (Comparative Example 2).

### Experimental Example 1: Microstructure Evaluation

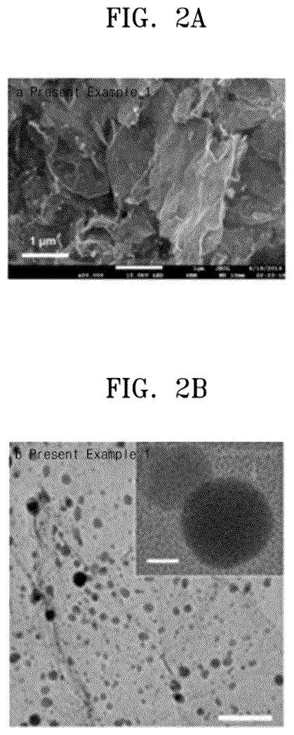

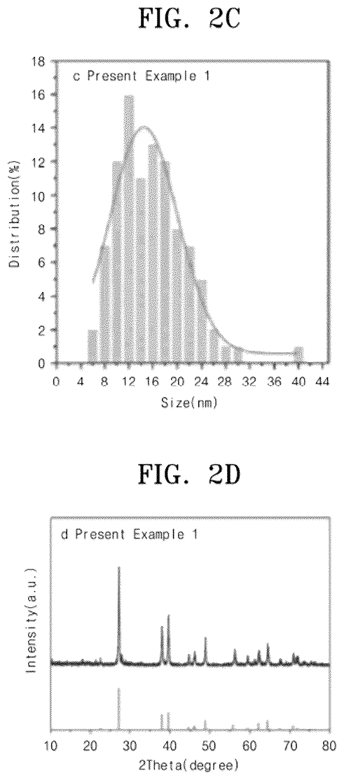

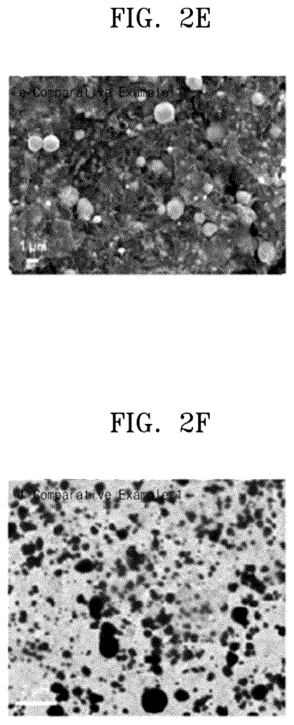

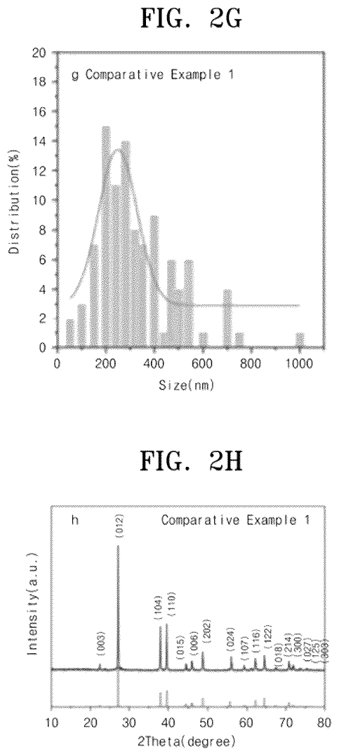

Microstructures according to Present Example 1 and Comparative Example 1 were analyzed, and the analysis results are shown in FIGS. 2A to 2H.

Specifically, a shape, a particle size distribution, and components of the carbon-alloy-based anode material nanocomposite contained in Present Example 1 were analyzed.

FIGS. 2A to 2H is a diagram showing results of microstructure analysis of alloy-based anodes according to Present Example 1 and Comparative Example 1 of the present disclosure.

FIG. 2A is a scanning electron microscope photograph of Present Example 1, FIG. 2B is a transmission electron microscope photograph of Present Example 1, FIG. 2C is a particle size distribution graph of Present Example 1, and FIG. 2D is an XRD analysis graph of Present Example 1.

FIG. 2E is a scanning electron microscope photograph of Comparative Example 1, FIG. 2F is a transmission electron microscope photograph of Comparative Example 1, FIG. 2G is a particle size distribution graph of Comparative Example 1, and FIG. 2H is an XRD analysis graph of Comparative Example 1.

As shown in FIGS. 2A to 2H, it was found that the carbon-alloy-based anode material nanocomposite contained in Present Example 1 has an embedded structure in which bismuth nanodots are uniformly dispersed and embedded in the reduced graphene, and it was found that a particle size of the bismuth nanodots is 10 to 11 nm on average.

As shown in FIGS. 2E to 2H, it was found that the carbon-alloy-based anode material bulk composite contained in Comparative Example 1 has an embedded structure in which bismuth particles are uniformly dispersed and embedded in the reduced graphene, but it was found that the bismuth particles have an average particle size of 240 to 260 nm.

### Experimental Example 2: Constant Current Charging/Discharging Evaluation

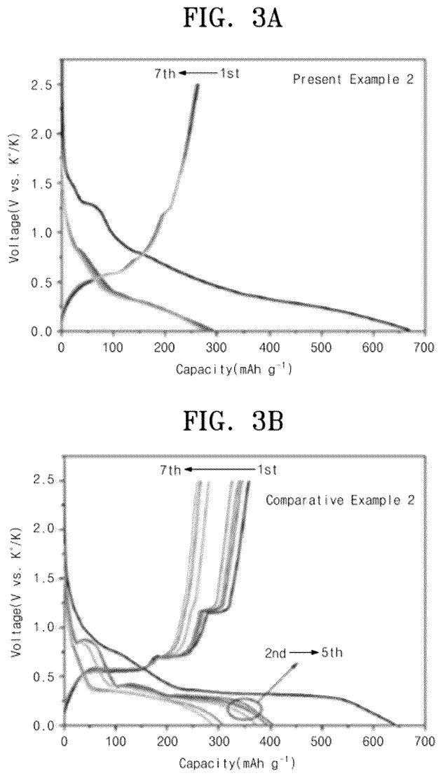

Constant current charging and discharging performances of the potassium ion batteries according to Present Example 2 and Comparative Example 2were evaluated in a voltage range of 0.01 to 2.5 V, and results are shown in FIGS. 3A and 3B. In addition, the constant current charging and discharging evaluation was conducted at a current density of 50 mAg⁻¹.

FIGS. 3A and 3B is a diagram showing results of constant current charging and discharging evaluation of metal ion batteries including alloy-based anodes according to Present Example 2 and Comparative Example 2 of the present disclosure.

FIG. 3A is a charging/discharging curve of Present Example 2, and FIG. 3B is a charging/discharging curve of Comparative Example 2.

Referring to FIGS. 3A and 3B, it was found that, while charging and discharging curves of 7 charging and discharging cycles of the potassium ion battery according to Present Example 2 are consistent, three flat potential pairs (0.87/1.18 V, 0.4/0.7 V, and 0.28/0.57 V) of a constant current charging/discharging curve visible in an initial charging and discharging curve disappeared and a rapid capacity reduction occurred in the potassium ion battery according to Comparative Example 2 as the charging and the discharging progress. In addition, in the case of Comparative Example 2, a capacity of 324 mAhg⁻¹ was exhibited at 5th discharging, and a 6th discharging capacity decreased to 264 mAhg⁻¹.

Such decrease in the capacity shows that an irreversible and incomplete phase transition occurred at the anode of the potassium ion battery according to Comparative Example 2.

On the other hand, in the case of Present Example 2, high charging/discharging reversibility appeared, and existing distinct redox behavior and flat potential, known as characteristics of an alloy-type anode, were not observed.

This is believed to be because potassium ions were stored via the one-phase reaction rather than the phase transition between the two phases. It is believed that the ion storage method via the diffusion-controlled reaction proceeded as the non-equilibrium reaction in which the phase transition occurs in the state in which the phase separation is delayed as the size of the particles is reduced to reduce the miscibility gap, increase the critical nucleation energy in an existing solid reaction theory, and increase potassium ion solubility of bismuth.

Therefore, the multi-phase reaction that occurs at equilibrium may be suppressed and the ions may be stored with the one-phase reaction. A sloping curve of Present Example 2 means that the miscibility gap was reduced. It may be seen that capacity reduction of the diffusion controlled reaction based alloying anode was greatly reduced with the diffusion-controlled reaction.

### Experimental Example 3: Electrochemical Performance Evaluation

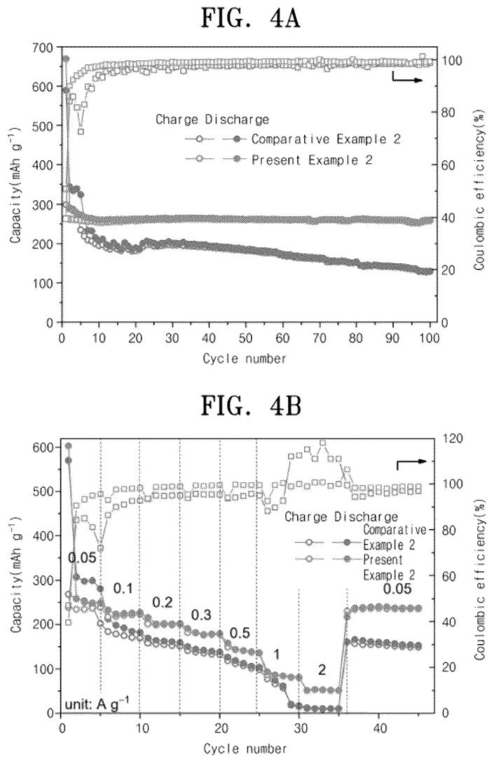

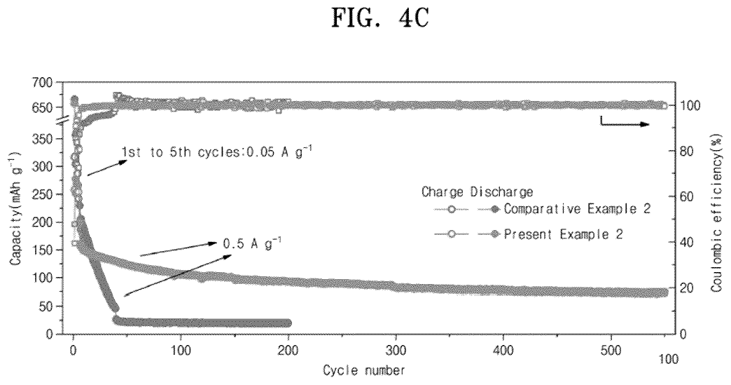

Electrochemical performances of the potassium ion batteries according to Present Example 2 and Comparative Example 2 were evaluated, and results are shown in FIGS. 4A to 4C. Specifically, battery lifespan characteristics via 100 charging/discharging cycles under a current density of 0.05 Ag⁻¹, battery output characteristics under current densities of 0.05, 0.1, 0.2, 0.3, 0.5, 1.0, and 2.0 Ag⁻¹, and battery lifespan characteristics via long charging/discharging cycle under a current density of 0.5 Ag⁻¹ were evaluated.

FIGS. 4A to 4C is a diagram showing electrochemical performance evaluation results of metal ion batteries including alloy-based anodes according to Present Example 2 and Comparative Example 2 of the present disclosure.

FIG. 4A is a graph showing the lifespan characteristics under the current density of 0.05 Ag⁻¹ of Present Example 2 and Comparative Example 2, FIG. 4B is a graph showing the output characteristics of Present Example 2 and Comparative Example 2, and FIG. 4C is a graph showing the lifespan characteristics under the current density of 0.5 Ag⁻¹ of Present Example 2 and Comparative Example 2.

As shown in FIG. 4A, it was found that Present Example 2 maintains a capacity of 260 mAhg⁻¹ even after the 100 cycles as a result of a highly reversible alloy reaction via the diffusion-controlled reaction, and has a very stable coulombic efficiency equal to or higher than 99% in initial 30 cycles.

Referring to FIG. 4B, while Comparative Example 2 exhibited low capacities of 243, 178, 154, 135, 102, 66, 11 mAhg⁻¹ under current densities of 0.05, 0.1, 0.2, 0.3, 0.5, 1.0, and 2.0 Ag⁻¹, Present Example 2 exhibited high reversible capacities of 250, 225, 202, 181, 141, 84, and 52 mAhg⁻¹ under current densities of 0.05, 0.1, 0.2, 0.3, 0.5, 1.0, and 2.0 Ag⁻¹, and exhibited excellent battery lifespan of 235 mAhg⁻¹ thereafter. It is determined that Present Example 2 exhibits high-output battery characteristics as the multi-phase reaction with slow kinetics characteristics is suppressed.

As shown in FIG. 4C, it was found that Present Example 2 exhibited a reversible capacity of 74 mAhg⁻¹ even after 550 cycles, but the reversible capacity rapidly decreased after 40 cycles and most of the battery characteristics are lost in Comparative Example 2.

### Experimental Example 4: Alloying Behavior Evaluation

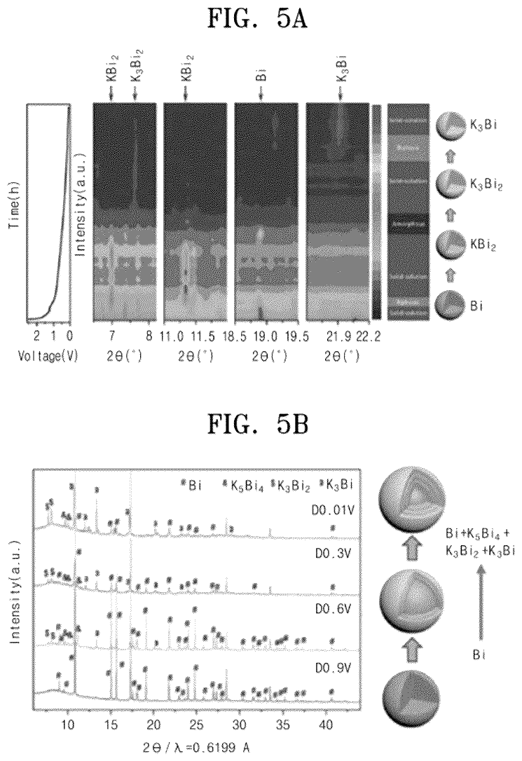

Real-time alloying behaviors according to Present Example 1 and Comparative Example 1 were analyzed, and results are shown in FIGS. 5A and 5B.

FIGS. 5A and 5B is a diagram showing alloying behavior evaluation results according to Present Example 1 and Comparative Example 1 of the present disclosure.

FIG. 5A is a contour graph of a synchrotron X-ray diffraction pattern of Present Example 1, and FIG. 5B is a result of analyzing a synchrotron X-ray diffraction pattern of Comparative Example 1.

As shown in FIGS. 5A and 5B, during an initial potassium alloying (potassiation) process, Present Example 1 exhibited the alloying behavior in the state in which the multi-phase reaction is suppressed step by step in an order of Bi, KBi₂, K₃Bi₂, and K₃Bi. Specifically, during the initial alloying process, a Bismuth peak located at 18.9° moved to a lower angle. This means that the phase separation was delayed and the solid solution phase transition reaction proceeded, and it was found that the one-phase reaction section continues for a long time after a short multi-phase reaction (Bi—KBi₂).

The multi-phase reaction occurred briefly only in a section where the phase transition occurs or the two-phase reaction did not occur, which corresponds to the reduction of the miscibility gap. In contrast, it may be seen that several potassium alloyed phases coexist, and in particular, three Bi—K alloyed phases (K₅Bi₄, K₃Bi₂, and K₃Bi) coexist at a discharge depth of 0.6 V in Comparative Example 1. This was a clear phase separation that may be observed in an existing alloy-based anode, and incomplete potassium alloying was found even at a final discharge depth of 0.01 V. This is because the potassium ions did not reach the inside of the large bismuth particles, and the large and heavy potassium ions diffused along a phase boundary where movement is relatively easy because of a slow diffusion rate. Because of such diffusion via the interface-controlled reaction, the multi-phase reaction, the coexistence of the several phases, and the incomplete potassiation reaction were caused.

### Experimental Example 5: Microstructure Evaluation During Charging Process

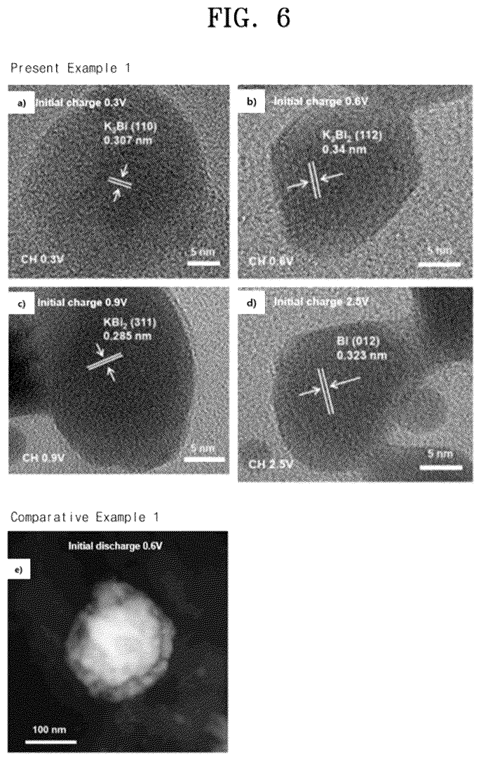

The microstructures during the charging process according to Present Example 1 and Comparative Example 1 were analyzed, and results are shown in FIG. 6.

FIG. 6 is a diagram showing results of microstructure analysis during a charging process according to Present Example 1 and Comparative Example 1 of the present disclosure.

Specifically, a) in FIG. 6 is a transmission electron microscope photograph in a 0.3 V charged state of Present Example 1, b) in FIG. 6 is a transmission electron microscope photograph in a 0.6 V charged state of Present Example 1, c) in FIG. 6 is a transmission electron microscope photograph in a 0.9 V charged state of Present Example 1, d) in FIG. 6 is a transmission electron microscope photograph in a 2.5 V charged state of Present Example 1, and e) in FIG. 6 is a transmission electron microscope photograph in the 0.6 V charged state of Comparative Example 1.

Referring to FIG. 6, it is shown that a 0.307 nm lattice spacing in the 0.3 V charged state corresponds to a (110) crystal plane of K₃Bi, a 0.340 nm lattice spacing in the 0.6 V charged state corresponds to a (112) crystal plane of K₃Bi₂, a 0.285 nm lattice spacing in the 0.9 V charged state corresponds to a (311) crystal plane of KBi₂, and a 0.323 nm lattice spacing in final charged state of 2.5 V corresponds to a (012) crystal plane of Bi, which indicate a complete dealloying behavior. A single phase may be seen in the several charged states, and the reversible single-phase transformation without the phase separation may be seen during the potassium alloying behavior of Present Example 1.

### Experimental Example 6: Microstructure Evaluation After 100 Charging/Discharging Cycles

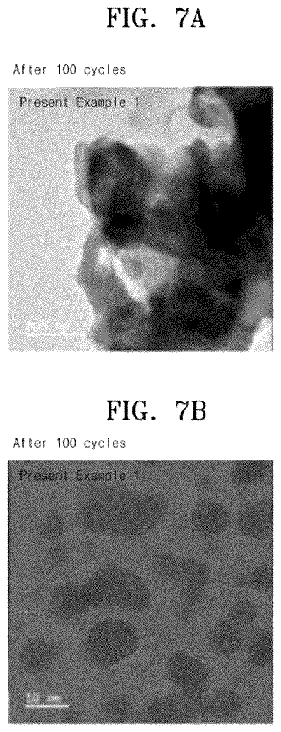

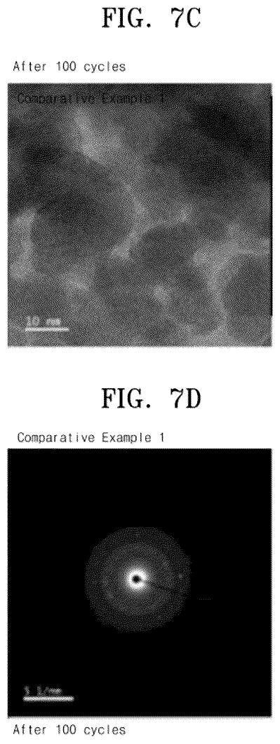

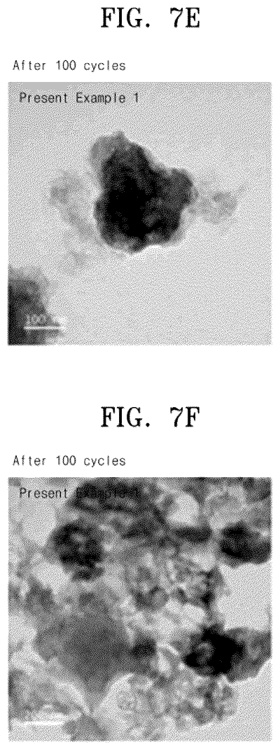

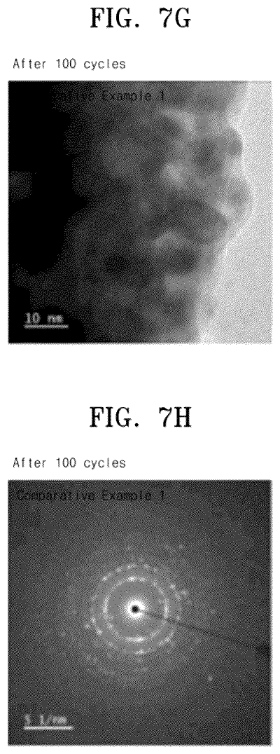

The microstructures after the 100 charging/discharging cycles according to Present Example 1 and Comparative Example 1 were analyzed, and results are shown in FIGS. 7A to 7H.

FIGS. 7A to 7H is a diagram showing results of microstructure analysis after 100 charging/discharging cycles of alloy-based anodes according to Present Example 1 and Comparative Example 1 of the present disclosure.

FIGS. 7A to 7C are transmission electron microscope photographs after the 100 charging/discharging cycles of Present Example 1, FIG. 7D is a result of selected area electron diffraction analysis after the 100 charging/discharging cycles of Present Example 1, FIGS. 7E to 7G are transmission electron microscope photographs after the 100 charging/discharging cycles of Comparative Example 1, and FIG. 7H is a result of the selected area electron diffraction analysis after the 100 charging/discharging cycles of Comparative Example 1.

Even after the 100 cycles, Present Example 1 maintained an original particle structure thereof, but, in Comparative Example 1, the particles fragmented and separated into small irregularly shaped particles and it was found that several phases coexist as the result of the selected area electron diffraction analysis.

The diffusion controlled reaction based alloying anodes through nanostructuring according to the embodiment of the present disclosure has been described as the specific embodiment, but this is only an example, and the present disclosure is not limited thereto, and should be construed as having the widest scope in accordance with the basic ideas disclosed herein. A person skilled in the art may combine and substitute the disclosed embodiments to implement an embodiment not specified, but this also does not deviate from the scope of the present disclosure. In addition, a person skilled in the art may easily change or modify the disclosed embodiment based on the present document, and it is clear that such changes or modifications also fall within the scope of the rights of the present disclosure.

The diffusion controlled reaction based alloying anodes through nanostructuring according to the embodiment of the present disclosure may use the carbon-alloy-based anode material nanocomposite, and delay the occurrence of the phase transition via the atomization and the complexation of the carbon-alloy-based anode material nanocomposite to induce the diffusion-controlled reaction that expands the one-phase reaction section, thereby achieving the long life and the high output in the next-generation ion battery.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A diffusion controlled reaction based alloying anodes through nanostructuring, the diffusion controlled reaction based alloying anode comprising:
a carbon-alloy-based anode material nanocomposite composed of a carbon matrix and alloy-based anode material particles, wherein the carbon-alloy-based anode material nanocomposite is formed via a diffusion-controlled induction process that is means for inducing the diffusion-controlled reaction.

2. The diffusion controlled reaction based alloying anode of claim 1, wherein the diffusion-controlled reaction is a reaction of extending a one-phase reaction section by delaying an occurrence of a phase separation.

3. The diffusion controlled reaction based alloying anode of claim 2, wherein the diffusion-controlled induction process corresponds to atomization of the alloy-based anode material particles via a dual-polymer protect-calcination and complexation of the alloy-based anode material particles and the carbon matrix.

4. The diffusion controlled reaction based alloying anode of claim 3, wherein the carbon-alloy-based anode material nanocomposite stores alkali ions with a multi-phase reaction suppressed via a non-equilibrium reaction by the diffusion-controlled reaction,
wherein the carbon-alloy-based anode material nanocomposite stores the alkali ions via the non-equilibrium reaction that is a reaction of forming a solid solution alloy as the alkali ions are intercalated into the alloy-based anode material particles with the phase separation delayed because of a reduction in a miscibility gap in the alloy-based anode material particles, an increase in critical nucleation energy, and an increase in solubility of the alkali ions.

5. The diffusion controlled reaction based alloying anode of claim 4, wherein the carbon-alloy-based anode material nanocomposite includes an embedded structure where the alloy-based anode material particles are dispersed and embedded in the carbon matrix,
wherein a weight ratio of the carbon matrix and the alloy-based anode material particles in the carbon-alloy-based anode material nanocomposite is in a range of 1:99 to 99:1.

6. The diffusion controlled reaction based alloying anode of claim 5, wherein the alloy-based anode material particles have a particle size satisfying a range of 0.5 to 30 nm.

7. The diffusion controlled reaction based alloying anode of claim 6, wherein the alloy-based anode material particles are nanodots made of one metal selected from a group of Bi, Si, Sn, Ge, Sb, P, Al, Zn, Ga, Pb, Ag, Au, and In, a metal oxide containing one element selected from the group, a metal nitride containing one element selected from the group, or a metal phosphide containing one element selected from the group.

8. The diffusion controlled reaction based alloying anode of claim 7, wherein the carbon matrix contains at least one material selected from a group consisting of reduced graphene, graphene, and a carbon nanotube.

9. A method for manufacturing a diffusion controlled reaction based alloying anodes through nanostructuring, the method comprising:
obtaining a carbon-alloy-based anode material nanocomposite composed of a carbon matrix and alloy-based anode material particles, wherein the carbon-alloy-based anode material nanocomposite is formed via a diffusion-controlled induction process that is means for inducing the diffusion-controlled reaction.

10. The method of claim 9, wherein the diffusion-controlled induction process includes performing atomization of the alloy-based anode material particles via a dual-polymer protect-calcination and complexation of the alloy-based anode material particles and the carbon matrix,
wherein the performing of the atomization of the alloy-based anode material particles and the complexation of the alloy-based anode material particles and the carbon matrix includes:
synthesizing a preliminary composite composed of preliminary alloy-based anode material particles coated with a first polymer and the carbon matrix;
coating a second polymer on a surface of the synthesized preliminary composite; and
calcining the preliminary composite coated with the second polymer in a mixed gas atmosphere.
